(19) United States
(12) Patent Application Publication
(10) Pub. No.: US 2024/0039094 A1
(43) Pub. Date: Feb. 1, 2024

(54) BATTERY

(71) Applicant: TOYOTA JIDOSHA KABUSHIKI KAISHA, Toyota-shi Aichi-ken (JP)

(72) Inventor: Takamasa MAEDA, Nisshin-shi Aichi-ken (JP)

(73) Assignee: TOYOTA JIDOSHA KABUSHIKI KAISHA, Toyota-shi Aichi-ken (JP)

(21) Appl. No.: 18/199,714

(22) Filed: May 19, 2023

(30) Foreign Application Priority Data
Jul. 28, 2022 (JP) 2022-120609

(51) Int. Cl. H01M 50/162; H01M 50/553; H01M 50/164; H01M 50/141

(52) U.S. Cl. CPC H01M 50/162; H01M 50/553; H01M 50/164; H01M 50/141

(57) ABSTRACT

The present disclosure provides a battery including an electrode body, a current collector terminal disposed on a side surface of the electrode body, and a laminate film covering the electrode body and the current collector terminal. The current collector terminal has a first surface opposed to the electrode body, a second surface opposed to the first surface, a third surface extending from an outer edge of the first surface toward the second surface side, and a first connecting surface connecting the third surface and the second surface. When the battery is viewed in the thickness direction, the boundary between the third surface and the first connecting surface is set to B₁, and the boundary between the first connecting surface and the second surface is set to B₂, the B₂ is located inside the B₁ in the thickness direction. The laminate film covers the third surface and the first connecting surface.

### CROSS-REFERENCE TO RELATED APPLICATION

This application claims priority to Japanese Patent Application No. 2022-120609 filed on Jul. 28, 2022, incorporated herein by reference in its entirety.

### BACKGROUND

### 1. Technical Field_ap

The present disclosure relates to a battery.

### 2. Description of Related Art

A battery such as a lithium ion secondary battery generally includes an electrode body having a positive electrode current collector, a positive electrode active material layer, an electrolyte layer, a negative electrode active material layer, and a negative electrode current collector. For example, the electrode body is sealed in an internal space surrounded by an exterior material. Japanese Unexamined Patent Application Publication No. 2011-108623 (JP 2011-108623 A) discloses a lithium polymer secondary battery including an electrode assembly, an exterior material surrounding the outside of the electrode assembly, and first and second covers sealing the exterior material, in which a first electrode terminal and a second electrode terminal are drawn to the outside via the first cover and the second cover, respectively. JP 2011-108623 A describes a laminate film as the exterior material.

### SUMMARY

A laminate film generally has a metal layer and a resin layer. The metal layer does not have moisture permeability. However, the resin layer has moisture permeability.

When moisture enters an internal space sealed with the laminate film via the resin layer, deterioration of the electrode body occurs.

The present disclosure has been made in view of the above circumstances. A main object of the present disclosure is to provide a battery capable of suppressing entry of moisture.
1 A battery including:
   an electrode body;
   a current collector terminal disposed on a side surface portion of the electrode body, the current collector terminal including
   a first surface facing the electrode body,
   a second surface facing the first surface,
   a third surface extending from an outer edge of the first surface toward the second surface side, and
   a first connecting surface connecting the third surface and the second surface; and
   a laminate film covering the electrode body and the current collector terminal and covering the third surface and the first connecting surface.
   When the battery is viewed in a cross section in a thickness direction, a boundary between the third surface and the first connecting surface is set to B₁, and a boundary between the first connecting surface and the second surface is set to B₂, the B₂ is located inward of the B₁ in the thickness direction.
2 The battery according to 1, in which the B₁ and the B₂ are connected by a single straight line, a plurality of straight lines, or a curved line when the battery is viewed in the cross section in the thickness direction.
3 The battery according to 1 or 2, in which:
   the current collector terminal includes a fourth surface extending from the outer edge of the first surface toward the second surface side and facing the third surface, and a second connecting surface connecting the fourth surface and the second surface;
   when the battery is viewed in the cross section in the thickness direction, a boundary between the fourth surface and the second connecting surface is set to B₃, and a boundary between the second connecting surface and the second surface is set to B₄, the B₄ is located inward of the B₃ in the thickness direction; and
   the laminate film covers the fourth surface and the second connecting surface.
4 The battery according to 3, in which the B₃ and the B₄ are connected by a single straight line, a plurality of straight lines, or a curved line when the battery is viewed in the cross section in the thickness direction.
5 The battery according to any one of 1 to 4, in which:
   a resin film is disposed between the current collector terminal and the laminate film; and
   an end portion of the resin film protrudes from an end portion of the laminate film.
6 A battery including:
   an electrode body;
   a current collector terminal disposed on a side surface portion of the electrode body, the current collector terminal including
   a first surface facing the electrode body,
   a second surface facing the first surface, and
   a third surface that extends from an outer edge of the first surface toward the second surface and in which a first groove is disposed; and
   a laminate film covering the electrode body and the current collector terminal and covering the first groove in the third surface.
7 A battery including:
   an electrode body;
   a current collector terminal disposed on a side surface portion of the electrode body, the current collector terminal including
   a first surface facing the electrode body,
   a second surface facing the first surface, and
   a third surface extending from an outer edge of the first surface toward the second surface side; and
   a laminate film covering the electrode body and the current collector terminal, the laminate film extending to the second surface while covering the third surface and not covering a part of an area of the second surface.

The present disclosure has an effect of providing the battery capable of suppressing entry of moisture.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating an electrode body in the present disclosure;

FIG. 2A is a schematic perspective view illustrating a battery according to the present disclosure;

FIG. 2B is a schematic perspective view illustrating a battery according to the present disclosure;

FIG. 3A is a schematic cross-sectional view illustrating a battery according to an embodiment of the present disclosure;

FIG. 3B is an enlarged view of a portion of FIG. 3A;

FIG. 4A is an explanatory view illustrating an issue of the present disclosure;

FIG. 4B is an enlarged view of area a in FIG. 4A;

FIG. 5A is a schematic cross-sectional view illustrating a battery according to an embodiment of the present disclosure;

FIG. 5B is a schematic cross-sectional view illustrating a battery according to an embodiment of the present disclosure;

FIG. 6A is a schematic perspective view illustrating a current collector terminal according to an embodiment of the present disclosure;

FIG. 6B is a schematic perspective view illustrating a current collector terminal according to an embodiment of the present disclosure;

FIG. 6C is a schematic perspective view illustrating a current collector terminal according to an embodiment of the present disclosure;

FIG. 6D is a schematic perspective view illustrating a current collector terminal according to an embodiment of the present disclosure;

FIG. 7 is a schematic side view illustrating an electrode body and a current collector terminal in the present disclosure;

FIG. 8 is a schematic cross-sectional view illustrating a current collector tab and a current collector terminal in the present disclosure;

FIG. 9 is a schematic cross-sectional view illustrating an electrode body in the present disclosure;

FIG. 10 is a schematic cross-sectional view illustrating a current collector terminal according to the present disclosure; and

FIG. 11 is a schematic cross-sectional view illustrating a current collector terminal in the present disclosure.

### DETAILED DESCRIPTION OF EMBODIMENTS

Hereinafter, a battery according to the present disclosure will be described in detail with reference to the drawings. The figures shown below are shown schematically. In the drawings shown below, the size and shape of each part are appropriately exaggerated for ease of understanding. In addition, in the present specification, when a mode in which another member is disposed with respect to a certain member is expressed, unless otherwise specified, the expression “on” or “below” includes both a case in which another member is disposed directly above or directly below a certain member so as to be in contact with the certain member, and a case in which another member is disposed above or below a certain member via another member.

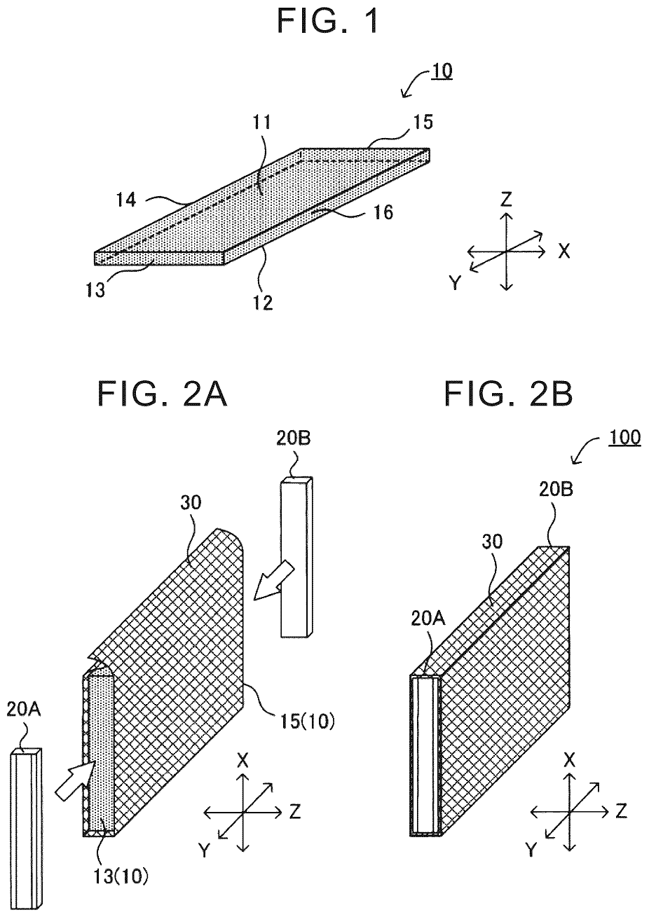

FIG. 1 is a schematic perspective view illustrating an electrode body according to the present disclosure. FIGS. 2A and 2B are schematic perspective views illustrating the disclosed batteries. The electrode body 10 shown in FIG. 1 has a top surface portion 11, a bottom surface portion 12 opposed to the top surface portion 11, and four side surface portions (a first side surface portion 13, a second side surface portion 14, a third side surface portion 15, and a fourth side surface portion 16) connecting the top surface portion 11 and the bottom surface portion 12. As shown in FIGS. 2A and 2B, the cell 100 includes an electrode body 10, a current collector terminal 20 (a positive electrode current collector terminal 20A and a negative electrode current collector terminal 20B) disposed on a side surface portion (a first side surface portion 13 and a third side surface portion 15) of the electrode body 10, and a laminate film 30 covering the electrode body 10 and the current collector terminal 20. In FIG. 1, and FIGS. 2A and 2B, the Z direction corresponds to the thickness direction of the cell. In FIG. 1, and FIGS. 2A and 2B, the X direction corresponds to the widthwise direction of the cell. In FIG. 1, and FIGS. 2A and 2B, the Y direction corresponds to the depth direction of the cell.

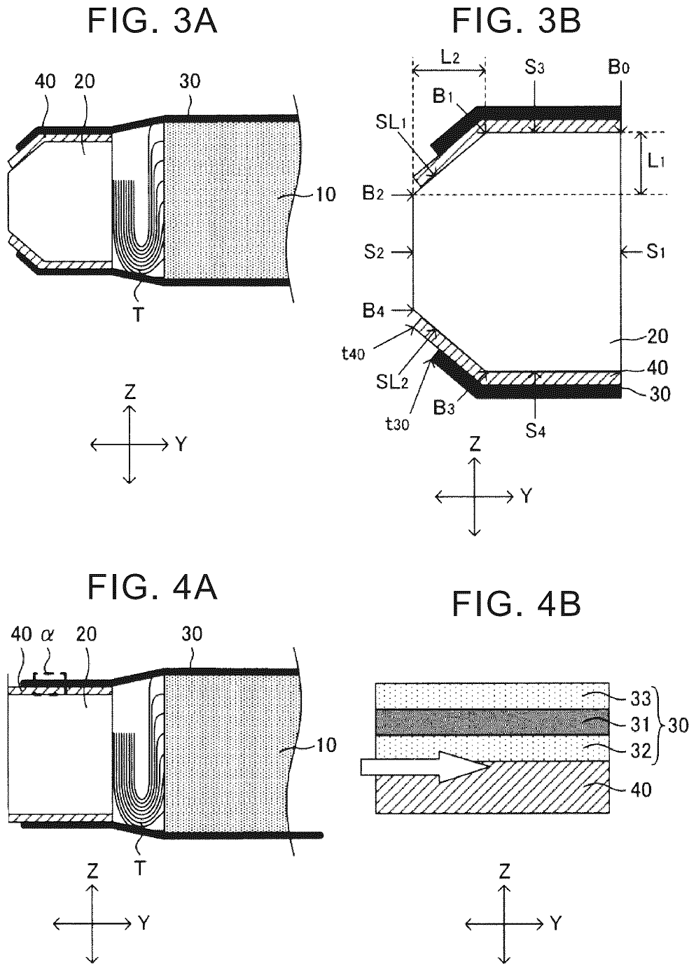

FIG. 3A is a schematic cross-sectional view illustrating a battery according to an embodiment of the present disclosure. FIG. 3B is an enlarged view of a portion of FIG. 3A. As shown in FIGS. 3A and 3B, the current collector terminal 20 has a first surface S₁, a second surface S₂, which faces the first surface S₁, a third surface S₃, which extends from the outer edge of the first surface S₁, to the second surface S₂, and a first connecting surface SL₁, which connects the third surface S₃, and the second surface S₂, to the electrode body 10. The electrode body 10 includes a current collector tab T. The current collector tab T and the current collector terminal 20 are electrically connected to each other. More specifically, the current collector tab T and the current collector terminal 20 are electrically connected by bonding the current collector tab T to the first surface Si of the electrode body 10. In addition, the border between the third surface S₃ and the first connecting surface SL₁ is defined as B₁. The border between the first connecting surface SL₁ and the second surface S₂ is set to B₂. B₂ is located inside B₁ in the thickness direction (Z direction). That is, in the thickness direction (Z direction), B₁ protrudes from B₂. In other words, a structure (notch structure) is formed in which a corner portion composed of an extension line of the second surface S₂ and an extension line of the third surface S₃ is cut by the first connecting surface SL₁. In addition, in FIGS. 3A and 3B, the laminate film 30 covers the third surface S₃ and the first connecting surface SL₁. Further, a resin film 40 for improving the adhesion between the current collector terminal 20 and the laminate film 30 is disposed.

According to the present disclosure, there is provided a battery capable of suppressing intrusion of moisture by disposing a laminate film so that the current collector terminal has a first connecting surface and covers the first connecting surface. Here, as shown in FIG. 4A, it is assumed that the current collector terminal 20 does not have the first connecting surface. Further, FIG. 4B is an enlarged view of the area a in FIG. 4A. The laminate film 30 shown in FIG. 4B includes a metal layer 31, an inner resin layer 32 disposed closer to the current collector terminal 20 than the metal layer 31, and an outer resin layer 33 disposed on a surface of the metal layer 31 opposite to the inner resin layer 32. The metal layer 31 does not have moisture permeability. Therefore, the moisture basically does not penetrate from the thickness direction Z of the battery. On the other hand, the inner resin layer 32 and the resin film 40 of the laminate film 30 have moisture permeability. Therefore, moisture may enter from the depth direction Y of the battery. The penetration of moisture in the depth direction Y largely depends on the cross-sectional area of the resin layer in the depth direction Y and the length of the penetration path. In particular, in the latter case, the longer the intrusion path, the less the intrusion of moisture. Comparing FIG. 3A and FIG. 4A, the current collector terminal 20 in FIG. 3A has the first connecting surface SL₁, so that the entry path of water in FIG. 3A is longer than the entry path of water in FIG. 4A. As a result, intrusion of moisture is suppressed. Further, for example, in FIG. 4A, when the length of the current collector terminal 20 in the depth direction Y is simply increased, the intrusion path is increased. On the other hand, when the current collector terminal 20 increases, the structural efficiency of the battery (the reaction effective area of the battery with respect to the area of the entire battery in the thickness direction Z) decreases. On the other hand, as shown in FIG. 3A, by providing the first connecting surface SL₁, the water intrusion path can be developed in the thickness direction Z, and a reduction in the structural efficiency of the cell can be suppressed.

### 1. Battery Configuration

A battery according to the present disclosure includes an electrode body, a current collector terminal, and a laminate film.

The electrode body according to the present disclosure generally has a top surface portion, a bottom surface portion opposed to the top surface portion, and a plurality of side surface portions connecting the top surface portion and the bottom surface portion. For example, the electrode body 10 shown in FIG. 1 has a top surface portion 11, a bottom surface portion 12 opposed to the top surface portion 11, and four side surface portions (a first side surface portion 13, a second side surface portion 14, a third side surface portion 15, and a fourth side surface portion 16) connecting the top surface portion 11 and the bottom surface portion 12. The normal direction of the top surface portion 11 and the bottom surface portion 12 is parallel to the thickness direction Z, and corresponds to the main surface of the electrode body 10.

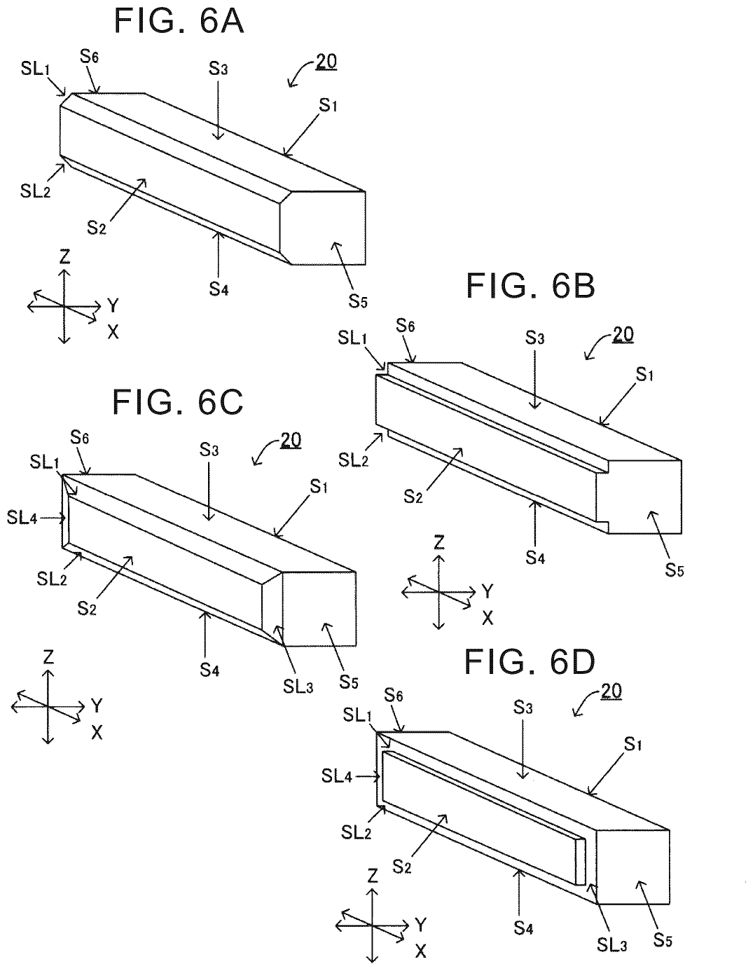

The current collector terminal in the present disclosure is disposed on a side surface portion of the electrode body. For example, in FIGS. 2A and 2B, the positive electrode current collector terminal 20A and the negative electrode current collector terminal are disposed on the first side surface portion 13 and the third side surface portion 15 of the electrode body 10, respectively. In addition, the laminate film in the present disclosure is disposed so as to cover the electrode body and the current collector terminal. In some embodiments, the laminate film is a single film. For example, in the case of the electrode body 10 shown in FIG. 1, the top surface portion 11, the fourth side surface portion 16, the bottom surface portion 12, and the second side surface portion 14 are covered with one laminate film 30. Further, for example, in the current collector terminal 20 shown in FIGS. 6A to 6D to be described later, the third surface S₃, the fifth surface S₅, the fourth surface S₄, and the sixth surface S₆ are covered with one laminate film 30. The laminate film 30 is welded to the current collector terminal 20.

As shown in FIG. 3B, the current collector terminal 20 has a first surface S₁, a second surface S₂, which is opposed to the electrode body (not shown), the first surface S₁, a third surface S₃, which extends from the outer edge of the first surface S₁, to the second surface S₂, and a first connecting surface SL₁, which connects the third surface S₃, and the second surface S₂. As shown in FIG. 3B, each of the first surface S₁, the second surface S₂, the third surface S₃, and the first connecting surface SL₁ may be a surface represented by a straight line in Y-Z plane. As shown in FIG. 3B, in Y-Z plane, the borders of the first surface S₁ and the third surface S₃ are set to B₀. As shown in FIG. 3B, in Y-Z plane, the border between the third surface S₃ and the first connecting surface SL₁ is set to B₁. As shown in FIG. 3B, in Y-Z plane, the borders of the first connecting surface SL₁ and the second surface S₂ are set to B₂.

In FIG. 3B, B₁ is the same as B₀ in the position in the thickness direction Z. In addition, B₂ is located on the inner side (the fourth surface S₄) of B₁ in the thickness direction Z. As shown in FIG. 3B, the distances of B₁ and B₂ in the thickness direction Z are set to L₁. As shown in FIG. 3B, the distances of B₁ and B₂ in the depth direction Y are set to L₂. Each of L₁ and L₂ is, for example, 1 mm or more, and may be 3 mm or more. The length of the current collector terminal 20 in the thickness direction Z is not particularly limited.

The length of the current collector terminal 20 in the thickness direction Z is, for example, equal to or greater than 5 mm and equal to or less than 15 mm. The distance between the first surface S₁ and the second surface S₂ in the depth direction Y is not particularly limited. The distance between the first surface S₁ and the second surface S₂ in the depth direction Y is, for example, equal to or greater than 5 mm and equal to or less than 15 mm.

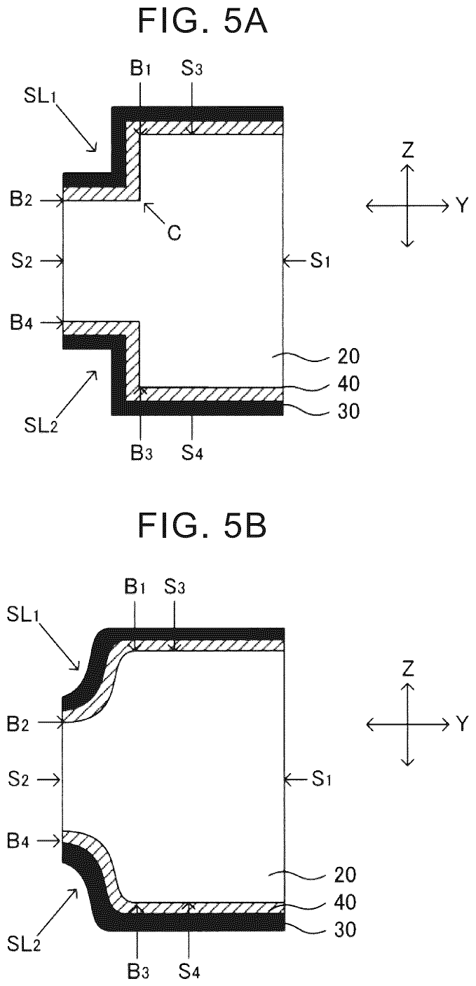

The laminate film 30 covers the third surface S₃ and the first connecting surface SL₁. In some embodiments, the laminate film 30 covers the entire surface of the third surface S₃. In addition, the laminate film 30 may cover at least a part of the first connecting surface SL₁, and may cover the entire surface of the first connecting surface SL₁. As shown in FIG. 3B, in Y-Z plane, B₁ and B₂ may be connected by one straight line. Specifically, in FIG. 3B, a cross section of the first connecting surface SL₁ is formed by a straight line connecting B₁ and B₂. Further, as shown in FIG. 5A, B₁ and B₂ may be connected by a plurality of straight lines in Y-Z plane. Specifically, in FIG. 5A, a cross section of the first connecting surface SL₁ is formed by a straight line connecting B₁ and C and a straight line connecting C and B₂. Further, as shown in FIG. 5B, B₁ and B₂ may be curved in Y-Z plane. Specifically, in FIG. 5B, a cross section of the first connecting surface SL₁ is formed by a curved line connecting B₁ and B₂.

As shown in FIG. 3B, and FIGS. 5A and 5B, the current collector terminal 20 may have a fourth surface S₄ extending from the outer edge of the first surface S₁ toward the second surface S₂ and facing the third surface S₃. Further, the current collector terminal may have a second connecting surface SL₂ connecting the fourth surface S₄ and the second surface S₂. Further, as shown in FIG. 3B, in Y-Z plane, the border of the fourth surface S₄ and the second connecting surface SL₂ is B₃. As shown in FIG. 3B, in Y-Z plane, the borders of the second connecting surface SL₂ and the second surface S₂ are set to B₄. B₄ is located inside B₃ (third surface S₃) in the thickness direction Z. The details of the fourth surface S₄ and the second connecting surface SL₂ are the same as those described in the third surface S₃ and the first connecting surface SL₁, respectively.

As shown in FIG. 3B, a resin film 40 may be disposed between the current collector terminal 20 and the laminate film 30. By disposing the resin film 40, the adhesion between the current collector terminal 20 and the laminate film 30 is improved. Further, by disposing the resin film 40, it is possible to suppress the occurrence of a short circuit even when a conductive foreign substance is present on the surface of the current collector terminal 20, for example. On the other hand, when the resin film 40 is disposed, moisture easily enters. On the other hand, in the present disclosure, by providing the first connecting surface SL₁, the intrusion path of water is lengthened, and intrusion of water is suppressed. Further, although not particularly illustrated, a resin film may not be present between the current collector terminal 20 and the laminate film 30, and the current collector terminal 20 and the laminate film 30 may be in direct contact with each other. Further, as shown in FIG. 3B, the end portion t₄₀ of the resin film 40 may protrude from the end portion t₃₀ of the laminate film 30. By causing the end portion t₄₀ to protrude from the end portion t₃₀ it is possible to suppress the adhesion failure even when the positional deviation of the current collector terminal 20 and the laminate film 30 occurs, for example.

As shown in FIGS. 6A to 6D, the current collector terminal 20 may have, in addition to the first surface S₁, the second surface S₂, the third surface S₃, and the fourth surface S₄, a fifth surface S₅, which extends from the outer edge of the first surface S₁ to the second surface S₂, and a sixth surface S₅, which extends from the outer edge of the first surface S₁ to the second surface S₂, and faces the fifth surface S₅. In FIGS. 6A to 6D, the first connecting surface SL₁ and the second connecting surface SL₂ respectively extend in the width direction (X direction) of the cell. Further, as shown in FIGS. 6C and 6D, the current collector terminal 20 may have at least one of a third connection surface SL₃ connecting the fifth surface S₅ and the second surface S₂, and a fourth connection surface SL₄ connecting the sixth surface S₆ and the second surface S₂. The details of the third connection surface SL₃ and the fourth connection surface SL₄ are the same as the details described in the above-described first connecting surface SL₁. In some embodiments, when the battery is viewed in a direction perpendicular to the thickness direction (when the battery is viewed in a cross-sectional view in a X-Y plane), the boundary between the fifth surface S₅ and the third connection surface SL₃ is set to B₅, and the boundary between the third connection surface SL₃ and the second surface S₂ is set to B₆, the B₆ may be located inside the B₅ in the width direction (X direction) of the battery. In some embodiments, the laminate film covers the fifth surface S₅ and the third connection surface SL₃. In some embodiments, when the battery is viewed in a direction perpendicular to the thickness direction (when the battery is viewed in a cross-sectional view in a X-Y plane), the boundary between the sixth surface S₆ and the fourth connection surface SL₄ is set to B₇, and the boundary between the fourth connection surface SL₄ and the second surface S₂ is set to B₈, the B₈ may be located inside the B₇ in the width direction (X direction) of the battery. In some embodiments, the laminate film covers the sixth surface S₆ and the fourth connection surface SL₄.

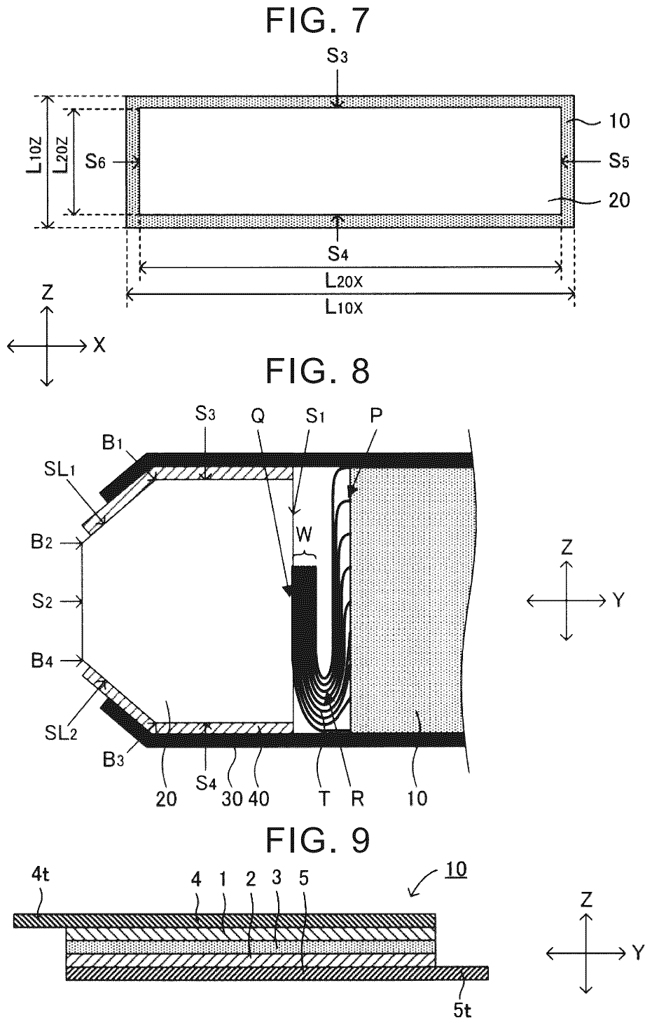

FIG. 7 is a schematic side view illustrating an electrode body and a current collector terminal in the present disclosure. In FIG. 7, the outer edge shape of the electrode body 10 and the outer edge shape of the current collector terminal 20 are rectangular. The length (total circumferential length) of the outer edge of the electrode body 10 is set to L₁₀, and the length (total circumferential length) of the outer edge of the current collector terminal is set to L₂₀. The ratio of L₂₀ to L₁₀ (L₂₀/L₁₀) is, for example, 0.7 or more and 1 or less. The ratio of L₂₀ to L₁₀ (L₂₀/L₁₀) may be 0.8 or more and 0.95 or less. Further, the length of the electrode body 10 in the thickness direction Z is set to L_{10z}, and the length of the current collector terminal 20 in the thickness direction Z is set to L_{20z}. The ratio of L_{20z} to L_{10z} (L_{20z}/L_{10z}) is, for example, 0.7 or more and 1.0 or less. The ratio of L_{20z} to L_{10z} (L_{20z}/L_{10z}) may be 0.8 or more and 0.95 or less. Further, the length of the electrode body 10 in the width direction X is set to L₁₀ₓ, and the length of the current collector terminal 20 in the width direction X is set to L₂₀ₓ. The ratio of L₂₀ₓ to L₁₀ₓ (L₂₀ₓ/L₁₀ₓ) is, for example, 0.7 or more and 1.0 or less. The ratio of L₂₀ₓ to L₁₀ₓ (L₂₀ₓ/L₁₀ₓ) may be 0.8 or more and 0.95 or less.

As shown in FIG. 8, in some embodiments, the current collector tab T has a root portion P that is an end portion on the electrode body 10 side, a connection portion Q for connection with the current collector terminal 20, and an intermediate portion R that connects the root portion P and the connection portion Q. The root portion P is an end portion (boundary portion) of the current collector tab T on the electrode body 10 side. The connection portion Q is a portion for connecting to the current collector terminal 20. The connection portion Q is a portion constituting the laminated connection portion W described later. The intermediate portion R is a portion connecting the root portion P and the connection portion Q. In some embodiments, each of the plurality of current collector tabs has a laminated connection portion in which the respective connection portions are laminated in the thickness direction. In FIG. 8, each of the connection portions Q in the plurality of current collector tabs T is laminated in the thickness direction of the current collector tabs T, whereby the laminated connection portions W are formed. In the laminated connection portion W, the connection portions Y are joined to each other (fixed to each other).

As shown in FIG. 8, in some embodiments, in a cross-sectional view of the electrode body 10 in the stacking direction (the thickness direction Z of the battery), the intermediate portion R has a curved structure in which portions of the intermediate portion R are curved so as to face each other. In some embodimenst, the intermediate portion R of at least one of the plurality of current collector tabs T has a curved structure. In the curved structure, portions of the intermediate portions Z that face each other may be arranged in direct contact with each other. In the curved structure, portions of the intermediate portions Z that face each other may be disposed with a space therebetween. In some embodiments, as shown in FIG. 8, the intermediate portion R of the plurality of current collector tabs T is curved in a U-shape.

### 2. Components of the battery

A battery according to the present disclosure includes an electrode body, a current collector terminal, and a laminate film.

### (1) Electrode Body

FIG. 9 is a schematic cross-sectional view illustrating an electrode body according to the present disclosure. The electrode body 10 in FIG. 9 includes a positive electrode active material layer 1, a negative electrode active material layer 2, an electrolyte layer 3 disposed in the positive electrode active material layer 1 and the negative electrode active material layer 2, a positive electrode current collector 4 that collects current in the positive electrode active material layer 1, and a negative electrode current collector 5 that collects current in the negative electrode active material layer 2. The electrode body 10 includes a positive electrode tab 4t continuously formed from the positive electrode current collector 4 and a negative electrode tab 5t continuously formed from the negative electrode current collector 5. In the case where the positive electrode active material layer, the electrolyte layer, and the negative electrode active material layer are each a power generation unit, the electrode body in the present disclosure may have one power generation unit or two or more power generation units.

The positive electrode active material layer contains at least a positive electrode active material. The positive electrode active material layer may further contain at least one of a conductive material, an electrolyte and a binder. Examples of the positive electrode active material include an oxide active material. Examples of the oxide active material include a rock salt layered active material such as LiNi_{⅓}Co_{⅓}Mn_{⅓}O₂, a spinel active material such as LiMn₂O₄, and an olivine active material such as LiFePO₄. Further, sulfur (S) may be used as the positive electrode active material. The shape of the positive electrode active material is, for example, particulate.

Examples of the conductive material include carbon material. The electrolyte may be a solid electrolyte. The electrolyte may also be a liquid electrolyte. The solid electrolyte may be an organic solid electrolyte such as a gel electrolyte. The solid electrolyte may be an inorganic solid electrolyte such as an oxide solid electrolyte or a sulfide solid electrolyte. In addition, the liquid electrolyte contains, for example, a support salt such as LiPF₆, and a solvent such as a carbonate-based solvent. Examples of the binder include a rubber-based binder and a fluoride-based binder.

The negative electrode active material layer contains at least a negative electrode active material. The negative electrode active material layer may further contain at least one of a conductive material, an electrolyte and a binder. Examples of the negative electrode active material include a metal active material such as Li, Si, a carbon active material such as graphite, and an oxide active material such as Li₄Ti₅O₁₂. The shape of the negative electrode active material is, for example, a particulate shape or a foil shape. The conductive material, the electrolyte and the binder are similar to those described above.

The electrolyte layer is disposed between the positive electrode active material layer and the negative electrode active material layer, and contains at least an electrolyte. The electrolyte may be a solid electrolyte. The electrolyte may also be a liquid electrolyte. The electrolyte is similar to those described above. The electrolyte layer may have a separator.

The positive electrode current collector collects current from the positive electrode active material layer. Examples of the material of the positive electrode current collector include metals such as aluminum, SUS, and nickel. Examples of the shape of the positive electrode current collector include a foil shape and a mesh shape. The negative electrode current collector collects the negative electrode active material layer. Examples of the material of the negative electrode current collector include metals such as copper, SUS, and nickel. Examples of the shape of the anode current collector include a foil shape and a mesh shape.

(2) Current collector terminal

The current collector terminal in the present disclosure is disposed on a side surface portion of the electrode body. The current collector terminal refers to a terminal having a current collector at least in part. The current collector is electrically connected to, for example, a current collector tab in the electrode body. The current collector terminal may be entirely a current collector. A part of the current collector terminal may be a current collector. The current collector terminal is made of, for example, aluminum, SUS, or the like.

(3) Laminate film

The laminate film in the present disclosure typically has a metal layer and an inner resin layer. The inner resin layer is welded to the current collector terminal. The laminate film may have an outer resin layer at a position opposite to the inner resin layer of the metal layer. Examples of the metal layer include metals such as aluminum and SUS. Examples of the resin layer include olefin-based resins such as polypropylene (PP) and polyethylene (PE). For example, polyethylene terephthalate (PET) or nylon may be used as the outer resin layer. The thickness of the metal layer is, for example, 30 μm or more and 60 μm or less. The thickness of the inner resin layer is, for example, 40 μm or more and 100 μm or less. The thickness of the outer resin layer is, for example, 20 μm or more and 60 μm or less. The thickness of the entire laminate film is, for example, 80 μm or more and 250 μm or less.

A resin film may be disposed between the laminate film and the current collector terminal. Examples of the resin films include olefinic resins such as polypropylene (PP) and polyethylene (PE).

### (4) Battery

The battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In some embodiments, it is used as a power supply for driving hybrid electric vehicle (HEV), plug-in hybrid electric vehicle (PHEV) or battery electric vehicle (BEV). In addition, the battery in the present disclosure may be used as a power source for a moving object (for example, a railway, a ship, or an aircraft) other than a vehicle. The battery in the present disclosure may be used as a power source of an electric product such as an information processing apparatus.

3. First modification

The present disclosure provides a battery including an electrode body, a current collector terminal disposed on a side surface portion of the electrode body, and a laminate film covering the electrode body and the current collector terminal. The current collector terminal has a first surface facing the electrode body, a second surface facing the first surface, and a third surface extending from an outer edge of the first surface toward the second surface. A first groove is disposed on the third surface. The laminate film covers the first groove on the third surface.

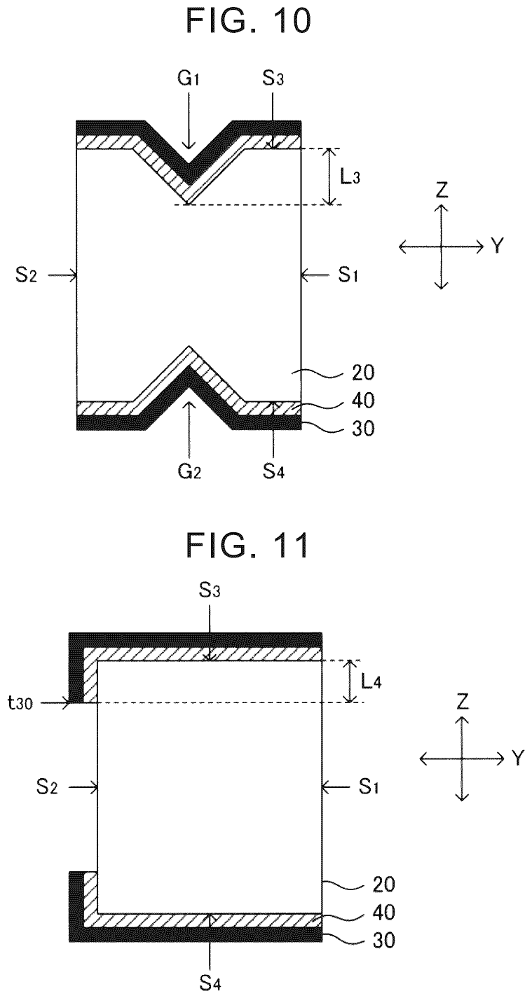

The current collector terminal 20 shown in FIG. 10 has a first surface S₁, which is opposed to the electrode body (not shown), a second surface S₂, which is opposed to the first surface S₁, and a third surface S₃, which extends from the outer edge of the first surface S₁, to the second surface S₂. In the third surface S₃, a first groove G₁, whose bottom is the center side of the current collector terminal 20, is disposed. The laminate film 30 covers the first groove G₁ in the third surface S₃. The current collector terminal 20 has a first groove G₁, and the laminate film 30 is disposed so as to cover the first groove G₁, thereby providing a battery capable of suppressing intrusion of moisture. In some embodiments, the first groove extends in the width direction X of the battery (the depth direction in FIG. 10).

As shown in FIG. 10, the depth of the first groove G₁ is L₃. L₃ is, for example, 0.5 mm or more. L₃ may be, for example, 1 mm or higher. The third surface may have only one first groove. The third surface may have a plurality of first grooves. In the latter case, the plurality of first grooves is arranged along the depth direction Y of the battery. Further, as shown in FIG. 10, the current collector terminal 20 may have a fourth surface S₄ extending from the outer edge of the first surface S₁ toward the second surface S₂ side and facing the third surface S₃. In the fourth surface S₄, a second groove G₂, whose bottom is the center side of the current collector terminal 20, is disposed. The details of the second groove G₂ are the same as those described in the first groove G₁. In the first modification, matters other than the groove are the same as those described above. The battery according to the first modification may have the above-described connection surface. The battery according to the first modification may not have the above-described connection surface.

4. Second modification

The present disclosure provides a battery including an electrode body, a current collector terminal disposed on a side surface portion of the electrode body, and a laminate film covering the electrode body and the current collector terminal. The current collector terminal has a first surface facing the electrode body, a second surface facing the first surface, and a third surface extending from an outer edge of the first surface toward the second surface. The laminate film extends to the second surface while covering the third surface. A partial region of the second surface is not covered with the laminate film.

The current collector terminal 20 shown in FIG. 11 has a first surface S₁, which is opposed to the electrode body (not shown), a second surface S₂, which is opposed to the first surface S₁, and a third surface S₃, which extends from the outer edge of the first surface S₁, to the second surface S₂. The laminate film 30 extends to the second surface S₂, while covering the third surface S₃. In addition, a part of the region in the second surface S₂ is not covered with the laminate film 30, and current collection is performed there. Since the laminate film 30 extends to the second surface S₂, a battery capable of suppressing intrusion of moisture is provided.

As shown in FIG. 11, the distance between the third surface S₃ and the end portion t₃₀ of the laminate film 30 covering the third surface S₃ in the thickness direction Z of the battery is L₄. L₄ is, for example, 0.5 mm or more. L₄ may be, for example, 1 mm or higher. Further, as shown in FIG. 11, the current collector terminal 20 may have a fourth surface S₄ extending from the outer edge of the first surface S₁ toward the second surface S₂ side and facing the third surface S₃. The laminate film 30 may extend to the second surface S₂, while covering the fourth surface S₄.

In the second modification, matters other than the position of the end portion of the laminate film are the same as those described above. The battery according to the second modification may have the above-described connection surface. The battery according to the second modification may not have the above-described connection surface. Further, the battery in the second modification may have a groove which is a feature of the first modification. The battery in the second modification may not have a groove that is a feature of the first modification.

Note that the present disclosure is not limited to the above-described embodiment. The above embodiment is an example. Any device having substantially the same configuration as the technical idea described in the claims in the present disclosure and having the same operation and effect is included in the technical scope of the present disclosure.

What is claimed is:

1. A battery comprising:
an electrode body;
a current collector terminal disposed on a side surface portion of the electrode body, the current collector terminal including
a first surface facing the electrode body,
a second surface facing the first surface,
a third surface extending from an outer edge of the first surface toward the second surface side, and
a first connecting surface connecting the third surface and the second surface; and
a laminate film covering the electrode body and the current collector terminal and covering the third surface and the first connecting surface, wherein when the battery is viewed in a cross section in a thickness direction, a boundary between the third surface and the first connecting surface is set to B₁, and a boundary between the first connecting surface and the second surface is set to B₂, the B₂ is located inward of the B₁ in the thickness direction.

2. The battery according to claim 1, wherein the B₁ and the B₂ are connected by a single straight line, a plurality of straight lines, or a curved line when the battery is viewed in the cross section in the thickness direction.

3. The battery according to claim 1, wherein:
the current collector terminal includes a fourth surface extending from the outer edge of the first surface toward the second surface side and facing the third surface, and a second connecting surface connecting the fourth surface and the second surface;
when the battery is viewed in the cross section in the thickness direction, a boundary between the fourth surface and the second connecting surface is set to B₃, and a boundary between the second connecting surface and the second surface is set to B₄, the B₄ is located inward of the B₃ in the thickness direction; and
the laminate film covers the fourth surface and the second connecting surface.

4. The battery according to claim 3, wherein the B₃ and the B₄ are connected by a single straight line, a plurality of straight lines, or a curved line when the battery is viewed in the cross section in the thickness direction.

5. The battery according to claim 1, wherein:
a resin film is disposed between the current collector terminal and the laminate film; and
an end portion of the resin film protrudes from an end portion of the laminate film.

6. A battery comprising:
an electrode body;
a current collector terminal disposed on a side surface portion of the electrode body, the current collector terminal including
a first surface facing the electrode body,
a second surface facing the first surface, and
a third surface that extends from an outer edge of the first surface toward the second surface and in which a first groove is disposed; and
a laminate film covering the electrode body and the current collector terminal and covering the first groove in the third surface.

7. A battery comprising:
an electrode body;
a current collector terminal disposed on a side surface portion of the electrode body, the current collector terminal including
a first surface facing the electrode body,
a second surface facing the first surface, and
a third surface extending from an outer edge of the first surface toward the second surface side; and
a laminate film covering the electrode body and the current collector terminal, the laminate film extending to the second surface while covering the third surface and not covering a part of an area of the second surface.
